(19) United States
(12) Patent Application Publication
(10) Pub. No.: US 2006/0294259 A1
(43) Pub. Date: Dec. 28, 2006

(54) Method and device for audience monitoring on multicast capable networks

(75) Inventors: Gergely Matefi, Budapest (HU); Janos Farkas, Kecskemet (HU); Tamas Elteto, Budapest (HU)

Correspondence Address: ERICSSON INC., 6300 LEGACY DRIVE, M/S EVR C11, PLANO, TX, 75024, US

(73) Assignee: TELEFONAKTIEBOLAGET LM ERICSSON (PUBL), Stockholm (SE)

(21) Appl. No.: 10/595,346

(22) PCT Filed: Oct. 24, 2003
(86) PCT No.: PCT/SE03/01647

§ 371 Date: Apr. 11, 2006

(51) Int. Cl. G06F 15/16

(52) U.S. Cl. 709/248

(57) ABSTRACT

The presented idea is a cheap solution for audience monitoring in multicast capable networks e.g. Ethernet, IP or UMTS. There is no need for user equipment in order to monitor the viewers' watching behavior. The measurement is done in the operator's network; therefore, there is no need to contact the end user. The idea can be applied in systems comprising multicast capable network contention server, network devices and user equipment. The content is carried in data packets to the end user. The network devices are remote manageable. The user can choose between several contents. The aim is to measure the user statistics regarding the chosen content. According to the invention it is enough to place a measurement host with our proposed software block in the network, which collects data from the network devices in the edge of the network periodically in order to make a content access survey.

### TECHNICAL FIELD OF THE INVENTION

The invention relates to a method for monitoring the use of different multicast services provided by a content server in a multicast capable access network to which users of the multicast services are connected.

### RELATED ART

In practice there are various systems and arrangements for monitoring the use of televisions. An example is monitoring the channel tuning habits of television viewers. The earliest such systems merely collected the data on site for eventual manual collection as to the television channels viewed and the times of viewing for various panels of viewers in order to determine market share and ratings of various television programs. Later, systems came into being for use with cable television systems with two-way communications over the cable system between the head end and various cable subscribers. In such a system, the television sets were typically interrogated periodically from the central location over the cable, with the channel selection and time information being sent back to the central location and logged for statistical compilation. Such systems have also been used in the past in pay television systems in which billing information was sent over the cable system from a central location to the various subscribers of the pay television system. The existing technologies include such systems in which a memory was provided at the remote location, i.e., at the television receiver, for accumulating data as to the channel being tuned in at the time. The accumulated data was then periodically transmitted over conventional telephone lines from the remote locations to the central location by telephone calls initiated by either the remote stations or the central location.

Systems for remotely accumulating data regarding the habits of television viewers and their qualitative reaction to television programming have today become important from the standpoint of market research. Several well-known systems enable the viewer's preferences to be monitored. For example, the effectiveness of television programming can be monitored by remote control devices used by audience members who may enter their reaction to broadcast programs displayed on their television screens. Such systems are disclosed in U.S. Pat. No. 4,107,734 and U.S. Pat. No. 4,308,554. In these systems, the information received by the remote control device is inputted to a localized interrogator and later dumped to a central computer. This apparatus may be used for determining which channel the set is on and viewer reactions to the displayed broadcast over that channel.

Another approach of the technical background has been to use “people meters”. With these people meters, each television set is furnished with one or more remote-control devices, which are pressed at the start and finish of viewing to record each person's watching patterns. Thus, this system operates effectively as an electronic diary in which the television viewing patterns of each individual are recorded. As the demands for more precise information about the individual viewers' habits and preferences developed, however, such electronic diaries were no longer sufficient.

Since these systems require active and continuous cooperation by members of the household, many households refuse to allow their installation. Others tire of the activity imposed on them and demand that the monitoring equipment be removed. The result may be a bias, which can be fatal to the usability and acceptance of the overall audience estimates produced by the system. For these reasons, operators of television audience measurement systems offer financial incentives to induce the pre-selected sample households to allow installation of the equipment and to continue its use. The effectiveness of these incentives, however, usually varies inversely with the socio-economic status of the households and with their values and attitudes. Obtaining and maintaining the cooperation of various types of households (those of single persons, the aged, certain ethnic populations, etc.) is also a continuing problem.

### SUMMARY OF THE INVENTION

The object of the invention is to provide a cost effective, reliable and real-time audience monitoring system, which eliminates the need of cooperation of households.

This is achieved in a method according to claim 1, in a monitoring device according to claim 6 and in a computer program product according to claim 4 or 5.

With such a method, monitoring device and computer program product a cheap audience monitoring system is achieved where the measurement is done in the operator's network and there is no need either for user equipment or to contact the end user in order to monitor his/her watching behavior.

Preferred embodiments are given in the dependent claims.

### BRIEF DESCRIPTION OF THE DRAWINGS

FIG. 1 is a schematic view of the measurement architecture of the invention.

FIG. 2 is a flowchart of the measurement process.

FIG. 3 is a schematic view of one embodiment of the monitoring device.

### DETAILED DESCRIPTION OF THE EMBODIMENTS

The system according to the invention is applicable in case of any multicast service carried in a multicast capable network, such as for example Ethernet, IP or UMTS networks. Example services using multicast capable networks are TV broadcasts, Pay TV or Radio. These services comprise multicast capable network content servers and user equipments. The audience monitoring according to the invention is done in the edge of the network and it is evaluated centrally.

The content, for example TV or radio channels, is carried in data packets to the end users. The network devices have to be multicast capable in order to support these kind of services. The network components are remote manageable. The user can choose between several programs provided by the content server. The aim of the invention is to measure the user statistics regarding the chosen content carried in multicast packets.

In network devices (for example Ethernet switches or IP routers) it is typically possible to get a list of the outgoing ports belonging to a specific multicast group. Each multicast group belongs to a specific content service of a service provider, e.g. a TV channel. In the edge of the network each port belongs to an individual user. The network devices copy the incoming multicast traffic only to ports belonging to the corresponding list. The lists can be retrieved by a remote measurement host, hereafter called monitoring device, which polls each network device in the edge of the service provider's network. The remote access can be implemented via Telnet (SSH), Web or SNMP interface of the switches. Other protocols or interfaces may also be applied e.g. COPS (Common Open Policy Service) Protocol or a vendor specific proprietary protocol or interface. A software block in the monitoring device can retrieve these lists periodically. This time period may be e.g. 5 minutes, which results in real-time monitoring of content (channel) selection of users. The resolution of the measurement is determined by this time period. The traffic generated by this measurement is negligible compared to the overall traffic in the network. Thus, it is enough to place one monitoring device with our proposed software block in the network, which collects data from the switches in the edge of the network periodically in order to make a content access survey.

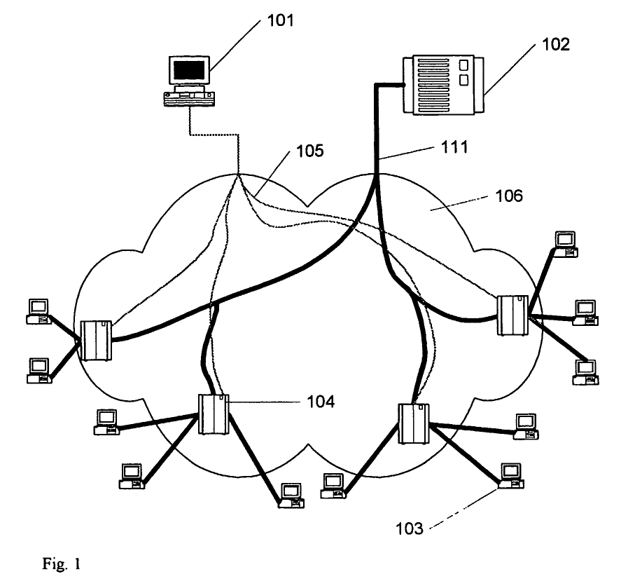

A monitoring system according to the invention is outlined in FIG. 1. A content server 102 is shown connected to an access network 106, which for example could be based on the Ethernet or IP technology. Multicast traffic 111 is sent from the content server 102 to plural network devices 104, which for example could be Ethernet switches or [P routers, which in turn are connected to the end users 103 of the service. A monitoring device 101, which could be a standard PC, is also connected to the network devices 104 through the access network 106. The traffic 105 from the monitoring device 101 might use different paths from the multicast traffic 111 in order to avoid interference but it is not necessary because the volume of the monitoring traffic 105 is negligible (in the range of 10 kbps) to the anticipated volume of the multicast traffic 111 (in the range of several Mbps). The multicast traffic 111 can be grouped into multicast groups whose root is the content server 102 and the leaves are the end-users 103. The advantage of the multicast technology is that the rate at which the content server 102 has to generate the packet stream 111 does not depend on the number of end-users 103 receiving the content. Instead, the network devices 104 maintain a list for each multicast group 111 containing the ports of the network device 104 through which this multicast traffic 111 should be forwarded, i.e. to which users or other devices the multicast traffic should be forwarded. Each port of the network devices 104 is connected either to another network device or to only one user and each multicast group 111 carries a specific content, for example a TV or radio channel. In the network devices 104 each multicast group has its own unique identifier, a multicast address. Furthermore the user can control which content (for example which TV channel) he/she wants to receive and thus the user chooses the multicast group via which he receives traffic. Lists showing the user ports that are connected to multicast groups (Ethernet/IP multicast address or other protocol identifier) are automatically created in the network devices having direct user connections. Incoming multicast traffic is copied only to ports belonging to the corresponding list. The lists are retrieved by the monitoring device 101 periodically for using this data for an evaluation of the user statistics, for example statistics for the viewing of different TV channels. In this way, the task of multiplexing the packet stream is distributed among the network devices 104 (e.g. Ethernet switches or IP routers). The lists are updated by multicast join requests issued by subsequent network devices and user equipments 103. For example the lists are updated each time a user changes TV channel.

The measurement method is based on the possibility that the lists in the network devices 104 can be retrieved and stored in the monitoring device 101. It is essential to measure the network devices 104 that contain such a list whose items can be directly related to the subscribers. Therefore the list retrievals should be done from these network devices. Note that not all network devices have this information. The protocol used for the retrieval might be different for network device 104 from different vendors. However standard protocols like Telnet, SSH, HTTP using a web based interface in the switches, SNMP or others (COPS) can be used in all major switch types.

The system according to the invention can also be applied in a 3G mobile network. According to for example the standard “Multimedia Broadcast/Multicast Service” 3GPP TS 22.146 multicast traffic can be transmitted in UMTS. There is a network device, e.g. the so-called GGSN, which maintains lists about multicast groups and ports and therefore the present invention can be applied to also 3G mobile networks.

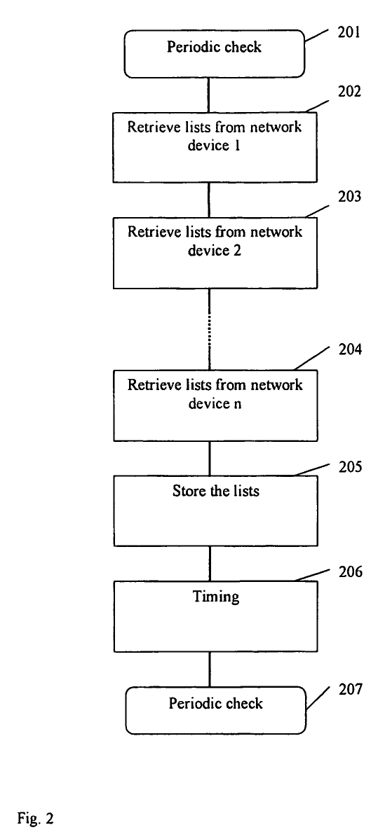

FIG. 2 shows the operation of the software block implemented in the monitoring device. The list retrievals are done in a loop.

Step 201: The beginning of the periodical list retrieval.

Step 202, 203, 204: Retrieval of the lists of ports joined to each multicast group from all the edge network devices (e.g. Ethernet switches or IP routers). In this case there are n network devices.

Step 205: The lists are stored in any proprietary format in the monitoring device.

Step 206: A timer is set for the desired measurement interval.

Step 207: End of the loop.

This algorithm can be implemented in several computer-programming languages.

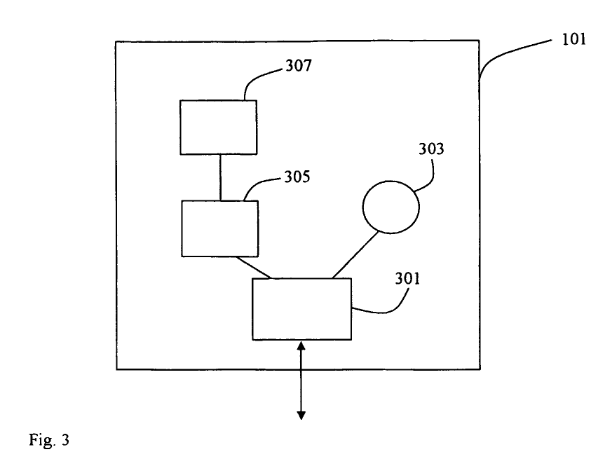

FIG. 3 shows schematically one embodiment of the monitoring device. The monitoring device comprises a retrieving means 301 adapted to retrieve information from the network devices regarding the relations between ports and multicast groups as described above. The retrieving means 301 is connected to a timer 303 which is adapted to periodically, according to a predefined time interval tell the retrieving means that it is time to retrieve the information. A storing means 305 is further connected to the retrieving means 301 and is adapted to store the retrieved information. An evaluating means 307 is possibly connected to the storing means 305 and is adapted to use the stored information to evaluate the use of the different contents in the multicast service. For example statistics of the use can be calculated in the evaluating means 307. An operator of the multicast service can check the evaluating means 307 directly for statistics of the use of the different contents, for example different TV channels. The evaluating step can of course instead be performed in another device than the monitoring device or the operator could fetch the information directly from the storing means 305 and do the evaluation himself.

The method according to the invention is implemented by means of a computer program product comprising the software code means for performing the steps of the method. The computer program product is run on a computer, the monitoring device, connected to the access network. The computer program is loaded directly or from a computer usable medium, such as a floppy disc, a CD, the Internet etc.

The present invention is not limited to the above-described preferred embodiments. Various alternatives, modifications and equivalents may be used. Therefore, the above embodiments should not be taken as limiting the scope of the invention, which is defined by the appending claims.

1-7. (canceled)

8. A method for monitoring the use of different multicast services, said multicast services provided by at least one content server as one multicast group for each service in a multicast capable access network to which users of the multicast services are connected through network devices, wherein the network devices comprise several ports and all users are connected to different ports, comprising the steps of:
periodically retrieving directly from each network device, by a monitoring device that is not integrated in the multicast system, information identifying which multicast groups are being forwarded through which ports in the network devices;
storing the information retrieved; and, evaluating the information to achieve a measure of the use of the different multicast services.

9. The method according to claim 8, wherein the access network is an Ethernet access network.

10. The method according to claim 8, wherein said step of periodically retrieving comprises using different paths than the multicast services use in the network for the retrieving of said information from the network devices.

11. A monitoring device connected to a multicast capable access network for monitoring the use of different multicast services which are provided by at least one content server as one multicast group for each service in the access network to which users of the multicast services are connected through network devices, wherein the network devices comprise several ports and all users are connected to different ports, and wherein it is not integrated as a part in the multicast system, comprising:
retrieving means adapted to periodically retrieve, directly from the network devices, information about which multicast groups are being forwarded through which ports in the network devices; and,
storing means connected to the retrieving means and adapted to store the information.

12. The monitoring device according to claim 11, further comprising an evaluating means connected to said storing means, said evaluating means adapted to evaluate said information to achieve a measure of the use of the different multicast services.

13. The monitoring device according to claim 11, further comprising a timer connected to the retrieving means, said timer adapted to periodically indicate to the retrieving means that it is time to retrieve the information from the network devices.

14. The monitoring device according to claim 11, wherein it is adapted to be connected to an Ethernet access network.
